(19) United States
(12) Patent Application Publication
(10) Pub. No.: US 2014/0317692 A1
(43) Pub. Date: Oct. 23, 2014

(54) INFORMATION PROCESSING UNIT, CLIENT TERMINAL DEVICE, INFORMATION PROCESSING SYSTEM, AND AUTHENTICATION PROCESSING METHOD

(71) Applicant: Fujitsu Limited, Kawasaki-shi (JP)

(72) Inventor: Jun Somekawa, Yokosuka (JP)

(73) Assignee: FUJITSU LIMITED, Kawasaki-shi (JP)

(21) Appl. No.: 14/243,571

(22) Filed: Apr. 2, 2014

(30) Foreign Application Priority Data
Apr. 23, 2013 (JP) 2013-089936

(51) Int. Cl. G06F 21/62; H04L 29/06

(52) U.S. Cl. CPC G06F 21/6281; H04L 63/0853
USPC 726/4

(57) ABSTRACT

An information processing unit includes a communication circuit configured to communicate with a client terminal device, a memory configured to store a program used for executing given processing, and a processor coupled to the memory, configured to issue, when the given processing includes processing of requesting authentication in accordance with a use request received from the client terminal device related to use of the program, an acquisition request of authentication information used for performing the authentication to the client terminal device, and determine, when the processor acquires an authentication result in accordance with the authentication information, whether or not the given processing that is to be performed by the program is executed, based on the authentication result.

### CROSS-REFERENCE TO RELATED APPLICATION

This application is based upon and claims the benefit of priority of the prior Japanese Patent Application No. 2013-089936, filed on Apr. 23, 2013, the entire contents of which are incorporated herein by reference.

### FIELD

The embodiment discussed herein is related to an information processing unit, an information processing system, and an authentication processing method.

### BACKGROUND

There is a virtual operating system (OS) environment including a virtual personal computer (PC) server and a client terminal, such as a thin client and the like. In the virtual OS environment, the function of a PC is virtualized and is functioned in a server. Known examples of the virtual OS environment include Windows (registered trademark) remote desk top, XennApp, VMware (registered trademark), and the like.

When a user logs on a virtual PC environment from a client terminal, a virtual PC server identifies the user using various authentication methods, permits, only when the virtual PC server determines that the user is an authorized user, the user to log on the virtual PC environment, and allows the user to use the virtual PC environment afterward.

As an example, a system including an information processing unit that receives an operation input of a user, a camera unit that photographs the user, the camera unit being provided with the information processing unit, and an authentication unit that stores user information that has been set in advance and performs user authentication determination via the information processing unit. In this system, the information processing unit includes a section that regularly detects a face area of the user in an image photographed by the camera unit and a section that extracts, when the number of detected face areas is one, face characteristic information from the face area and transmits the extracted face characteristic information to the authentication unit. The authentication unit includes a section that executes, when the user is authenticated based on the transmitted face characteristic information, processing corresponding to the operation input. For example, Japanese Laid-open Patent Publication No. 2009-211381 discloses such a system.

### SUMMARY

According to an aspect of the invention, an information processing unit includes a communication circuit configured to communicate with a client terminal device, a memory configured to store a program used for executing given processing, and a processor coupled to the memory, configured to issue, when the given processing includes processing of requesting authentication in accordance with a use request received from the client terminal device related to use of the program, an acquisition request of authentication information used for performing the authentication to the client terminal device, and determine, when the processor acquires an authentication result in accordance with the authentication information, whether or not the given processing that is to be performed by the program is executed, based on the authentication result.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example configuration of an information processing system according to an embodiment;

FIG. 2 is a diagram illustrating an example hardware configuration of a client terminal according to the embodiment;

FIG. 3 is a diagram illustrating an example configuration of a virtual PC server according to the embodiment;

FIG. 4 is a diagram illustrating an example configuration of an authentication server according to the embodiment;

FIG. 5 is a block diagram illustrating a functional configuration of an information processing system according to an embodiment;

FIG. 6 is a diagram illustrating an example functional authentication table according to the embodiment;

FIG. 7 is a diagram illustrating an example authentication request according to the embodiment;

FIG. 8 is a diagram illustrating an example user authentication table according to the embodiment;

FIG. 9 is a diagram conceptually illustrating a series of processes according to the embodiment;

FIG. 10 is a flowchart illustrating an example operation of an application processing unit according to the embodiment;

FIG. 11 is a flowchart illustrating an example operation of an authentication management unit according to the embodiment;

FIG. 12 is a flowchart illustrating an example operation of an authentication relay unit according to the embodiment;

FIG. 13 is a flowchart illustrating example processing of an authentication unit according to the embodiment;

FIG. 14 is a block diagram illustrating a function of a virtual PC according to a first modified example;

FIG. 15 is a diagram illustrating an example function authentication table according to the first modified example; and

FIG. 16 is a diagram illustrating an example app authentication table according to a second modified example.

### DESCRIPTION OF EMBODIMENT

In the above-described system, the client terminal controls both of a display and a keyboard based on a result of authentication performed by the authentication unit, and thus, the virtual PC server performs control over whether or not a user may operate each of all of applications that operate in the virtual PC. Therefore, when the user is determined to be a user authorized to use the virtual PC by authentication performed when the user logs on, the user may use all of the applications in the virtual PC even if it is not desirable to permit the user to use a certain application. For this reason, authentication is preferably performed for each application.

However, for applications that operate in the above-described virtual PC, authentication is not performed for each application using the authentication unit coupled to the client terminal. That is, there is a problem in which, if only authentication of a known method is used, control over whether or not a user may use each of all applications that operates in the virtual PC is not performed in the virtual OS environment and therefore usability is reduced.

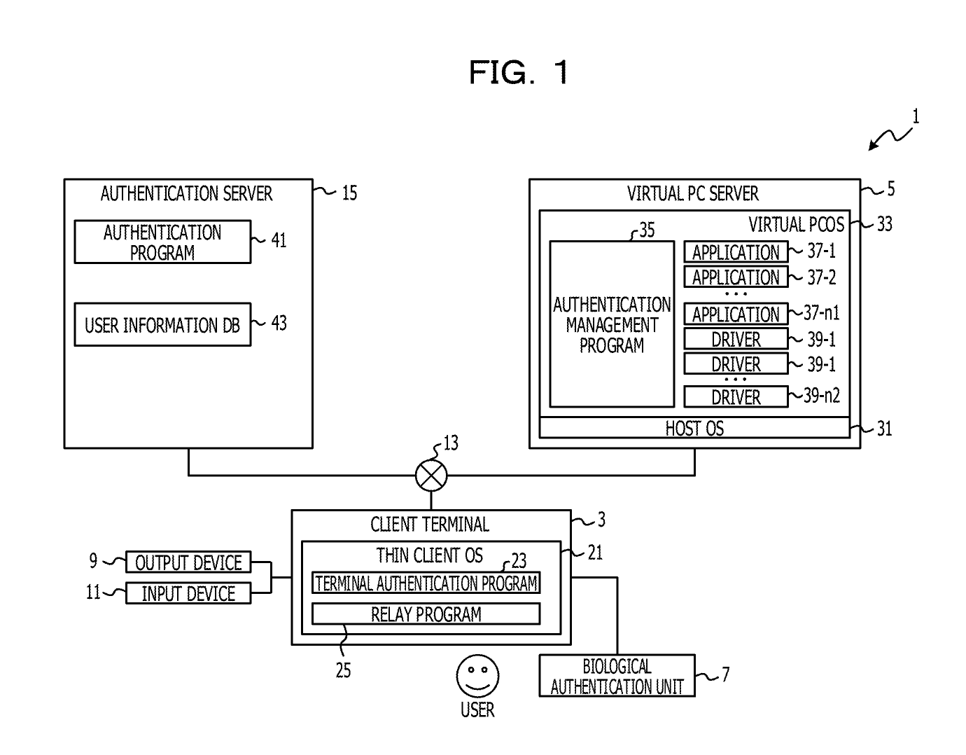

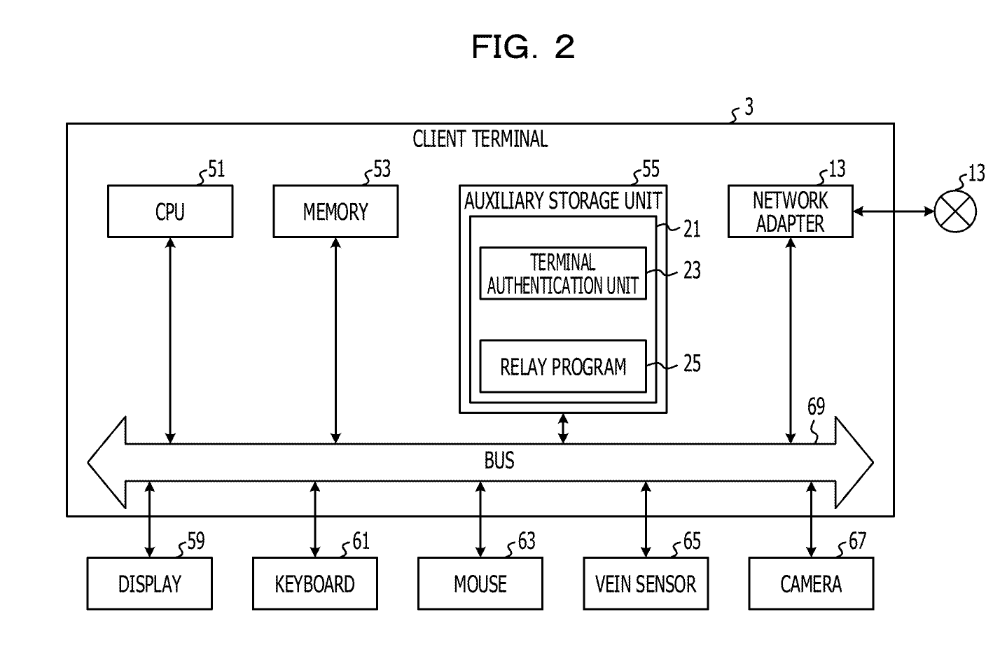

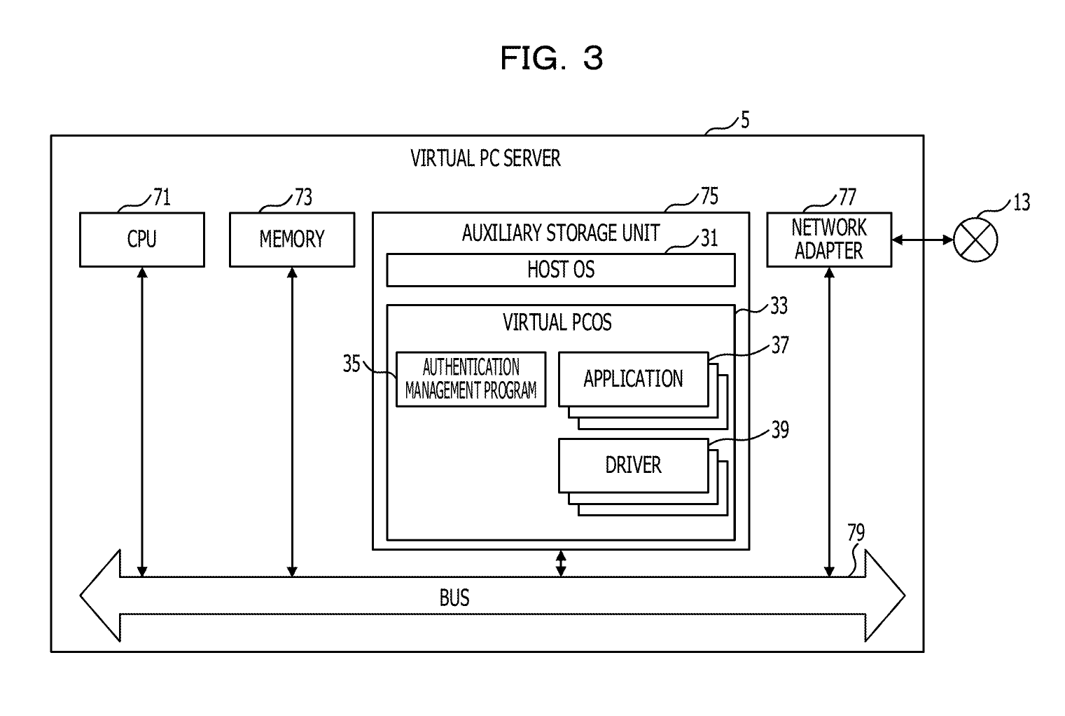

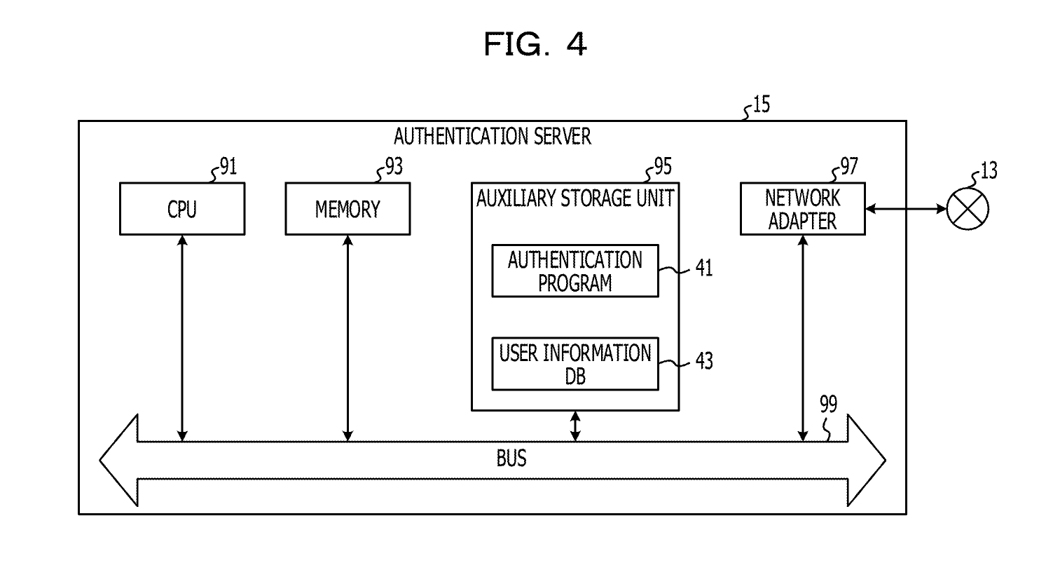

An information processing system 1 according to an embodiment will be hereinafter described with reference to the accompanying drawings. FIG. 1 is a diagram illustrating an example configuration of the information processing system 1 according to the embodiment, FIG. 2 is a diagram illustrating an example hardware configuration of a client terminal 3, FIG. 3 is a diagram illustrating an example configuration of a virtual PC server 5, and FIG. 4 is a diagram illustrating an example configuration of an authentication server 15.

As illustrated in FIG. 1, the information processing system 1 is a system in which the virtual PC server 5, the client terminal 3, and the authentication server 15 are coupled with one another via an information network 13. The client terminal 3 includes a thin client OS 21. The thin client OS 21 is a program that is executed in the client terminal 3 and transmits and receives information to and from the virtual PC server 5 to thereby cause the client terminal 3 to function as a thin client terminal that causes the virtual PC server 5 to execute predetermined processing. The virtual PC server 5 includes a virtual PCOS 33 and is caused to function as a virtual PC server for the client terminal 3 by executing the virtual PCOS 33. The virtual PC server is an information processing unit that transmits and receives information to and from the client terminal 3 to thereby provide an environment in which each type of processing is executed based on an instruction transmitted from the client terminal 3.

The client terminal 3 further includes a terminal authentication program 23 and a relay program 25 each of which is operated on the thin client OS 21. A biological authentication unit 7, an output device 9, and an input device 11 are coupled to the client terminal 3. The biological authentication unit 7, the output device 9, and the input device 11 may be provided in the client terminal 3.

The terminal authentication program 23 is a program used for transmitting authentication information obtained by the client terminal 3 to the authentication server 15 to perform authentication for use of the virtual PC server 5. The relay program 25 is a program used for accepting, after use of the virtual PC server 5 is permitted, a request for transmitting authentication information from the virtual PC server 5 and transmitting corresponding authentication information.

The virtual PC server 5 further includes a host OS 31, and the virtual PCOS 33 operates on the host OS 31. The host OS 31 is a basic software used for causing the virtual PCOS 33 to function as, for example, a standard computer.

The virtual PC server 5 further includes an authentication management program 35, at least one application 37-n1, and at least one driver 39-n2. In this case, each of n1 and n2 is an integer of 1 or more. The at least one application 37-n1 as a whole or a representative of the at least one application 37-n1 will be also referred to as an “application 37,” and the driver 39-n2 as a whole or a representative driver 39-n2 will be also referred to as a “driver 39.” Each of the application 37 and the driver 39 is a program used for performing predetermined processing. Specifically, the driver 39 is a program used for perform drive control of a device.

The authentication server 15 includes an authentication program 41 and user information DB 43, and is an information processing unit that performs authentication based on authentication information transmitted from the virtual PC server 5 or the client terminal 3. The authentication program 41 is a program used for executing authentication. The user information DB 43 is information to which the authentication program 41 refers when the authentication program 41 executes authentication.

The information processing system 1 has the above-described configuration and thus, in the information processing system 1, processing performed for virtualization of the PC is performed mainly in the virtual PC server 5, and a screen of a result of processing performed in the virtual PC server 5 is displayed in the client terminal 3 side. Thus, the information processing system 1 serves as a system which operates as if the processing were performed in the client terminal 3. For example, a display unit is not coupled to the virtual PC server 5 but, by reflecting the screen of the virtual PC server 5 to the client terminal 3, the screen of the virtual PC server 5 is visualized so as to be actually visually recognized. In order to display the screen of the virtual PC server 5 on the screen of the client terminal 3, a method in which image data of the entire screen of the virtual PC server 5 then or a modified part thereof is transmitted to the client terminal 3 and is displayed on a display of the client terminal 3 is performed.

As illustrated in FIG. 2, the client terminal 3 includes a central processing unit (CPU) 51, a memory 53, an auxiliary storage device 55, and a network adapter 57, and these members are coupled to one another via a bus 69. A display 59, a keyboard 61, a mouse 63, a vein sensor 65, a camera 67, and the like are coupled to the client terminal 3 via the bus 69.

The CPU 51 is an arithmetic processing unit that performs an operation in accordance with each type of processing performed in the client terminal 3 and controls the operation of the display 59 coupled thereto or the like. The memory 53 is a storage device from and to which data may be read out and written as appropriate. The auxiliary storage device 55 is a storage device, such as a hard disk. The auxiliary storage device 55 stores, for example, the thin client OS 21, the terminal authentication program 23, and the relay program 25. The CPU 51 reads out and executes the thin client OS 21, the terminal authentication program 23, or the relay program 25 on the memory 53.

The network adapter 57 is a transmission and reception device that transmits and receive information to and from other devices, such as the virtual PC server 5 and the authentication server 15 via the information network 13. Note that the client terminal 3 may be a standard computer that independently performs various types of processing, and may be a dedicated terminal for a thin client, which operates as a client terminal of the virtual PC server 5 at any time. In this case, the client terminal 3 includes a basic software in accordance with each embodiment.

The display 59 is an example of the output device 9. As the output device 9, an audio output device or the like may be provided. The keyboard 61 and the mouse 63 are examples of the input device 11. The vein sensor 65 and the camera 67 are examples of the biological authentication unit 7. The vein sensor 65 is a detection device that reads out a vein pattern of a finger or a palm for vein authentication. The camera 67 is, for example, a photographing device that photographs the face of a user for face authentication. As the biological authentication unit 7, in addition to the vein sensor 65 and the camera 67, a finger print sensor, an iris authentication sensor, and the like may be used. Moreover, not only for biological authentication but also for individual authentication, a device that acquires information with which an individual may be identified may be used.

As illustrated in FIG. 3, the virtual PC server 5 includes a CPU 71, a memory 73, an auxiliary storage device 75, and a network adapter 77, and these members are coupled to one another via a bus 79. The auxiliary storage device 75 stores the host OS 31, the virtual PCOS 33, the authentication management program 35, the application 37, and the driver 39.

The CPU 71 is an arithmetic processing unit that performs an operation in accordance with each type of processing performed in the virtual PC server 5. The memory 73 is a storage device from and to which data may be read out and written as appropriate. The memory 75 is a storage device, such as a hard disk. The CPU 71 reads out and executes, for example, the host OS 31, the virtual PCOS 33, the authentication management program 35, the application 37, or the driver 39 on the memory 73. The network adapter 77 is a transmission and reception device that transmits and receives information to and from other devices, such as the client terminal 3 and the authentication server 15 via the information network 13.

As illustrated in FIG. 4, the authentication server 15 includes a CPU 91, a memory 93, an auxiliary storage device 95, and a network adapter 97 and these members are coupled to one another via a bus 99. The auxiliary storage device 95 stores the authentication program 41 and user information data base (DB) 43. Although not illustrated in FIG. 4, the auxiliary storage device 95 stores a basic software and the like used for operating the authentication server 15.

The CPU 91 is an arithmetic processing unit that performs an operation in accordance with each type of processing performed in the authentication server 15. The memory 93 is a storage device from and to which data may be read out and written as appropriate. The auxiliary storage device 95 is a storage device, such a hard disk. The auxiliary storage device 95 stores the authentication program 41 and the user information DB 43. The CPU 91 reads out and executes, for example, the authentication program 41 on the memory 93. The network adapter 97 is a transmission and reception device that transmits and receives information to and from other devices, such as the client terminal 3 and the virtual PC server 5 via the information network 13.

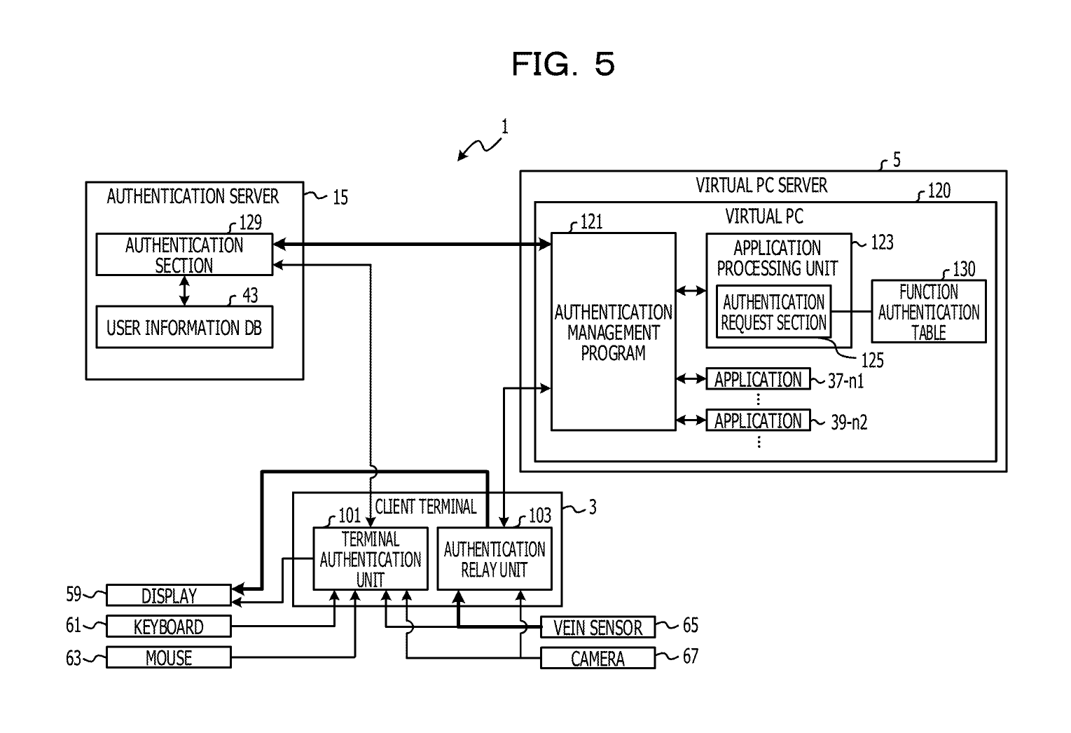

A configuration of the information processing system 1 will be further described. FIG. 5 is a block diagram illustrating a functional configuration of the information processing system 1. As illustrated in FIG. 5, the client terminal 3 executes the terminal authentication program 23 and the relay program 25 on the thin client OS 21 and thereby has functions of a terminal authentication unit 101 and an authentication relay unit 103.

When the terminal authentication unit 101 requests a permission for use of the virtual PC server 5, the terminal authentication unit 101 controls the vein sensor 65, the camera 67, and the like to acquire authentication information and transmits the authentication information to the authentication server 15. When use of the virtual PC server 5 is permitted and then a request for authentication information is issued from the virtual PC server 5, the authentication relay unit 103 controls the vein sensor 65, the camera 67, and the like for the purpose of acquiring authentication information in accordance with the request, and acquires the authentication information. Furthermore, the authentication relay unit 103 transmits the authentication information to the virtual PC server 5 or the authentication server 15 via the network adapter 57.

Then, the terminal authentication unit 101 issues a use request to the virtual PC server 5 based on information input via the keyboard 61, the mouse 63, or the like. The terminal authentication unit 101 and the authentication relay unit 103 control the operations of the vein sensor 65 and the camera 67 in accordance with authentication information which are to be acquired, and acquire authentication information. In this case, in order to acquire authentication information that enables execution of authentication, the terminal authentication unit 101 and the authentication relay unit 103 preferably perform, for example, processing of providing to a user how to place the user's hand to the vein sensor 65 used for detection of the user's vein, and the like. Authentication information that is to be acquired is preferably subjected to processing, such as encryption and the like, which is suitable for transmission. The terminal authentication unit 101 and the authentication relay unit 103 control the display 59 to perform display.

The virtual PC server 5 executes the host OS 31 to cause one or more virtual PCs 120 in that state. The virtual PC 120 is a function that is realized by executing the virtual PCOS 33. Note that, in FIG. 5, one virtual PC 120 is illustrated. The virtual PC 120 has functions of an authentication management unit 121 and an application processing unit 123.

The authentication management unit 121 is a function that is realized by executing the authentication management program 35. The application processing unit 123 is a function that is realized by executing, for example, an application 37-1. The application processing unit 123 includes an authentication request section 125. The authentication request section 125 is a function of requesting the authentication management unit 121 for authentication. A function authentication table 130, the application 37, the driver 39, and the like are stored in the auxiliary storage device 75 as described above.

The application processing unit 123 performs processing based on the application 37. When the client terminal 3 issues, to the application processing unit 123, a use request, such as a request for use of the application 37 or the driver 39, a request for predetermined processing, and the like, which desires authentication, the authentication request section 125 issues a request for authentication to the authentication management unit 121. The authentication request section 125 refers to the function authentication table 130 and transmits an authentication request 145 of a type in accordance with a function corresponding to the use request to the client terminal 3 via the authentication management unit 121.

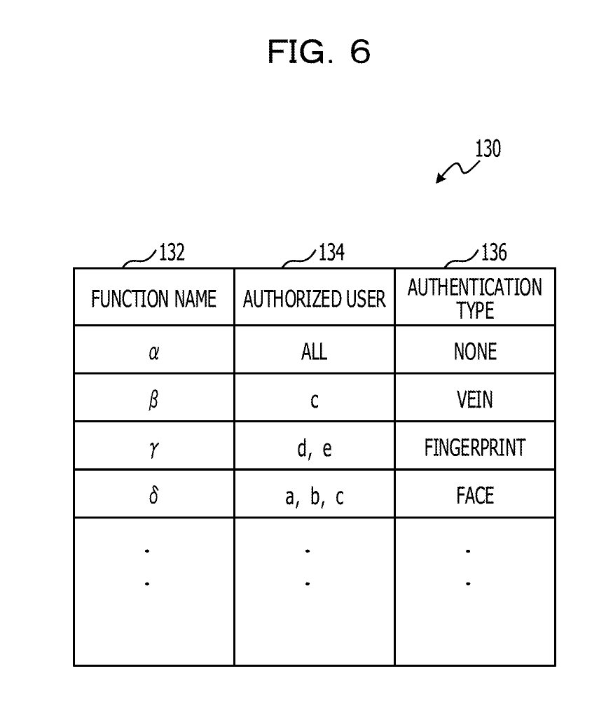

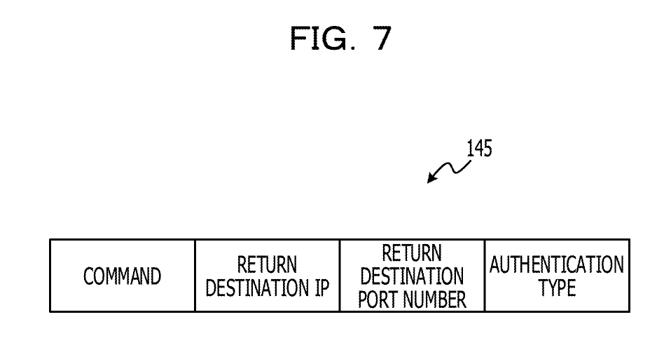

Now, the function authentication table 130 and the authentication request 145 will be described with reference to FIG. 6 and FIG. 7. FIG. 6 is a diagram illustrating an example of the functional authentication table 130, and FIG. 7 is a diagram illustrating an example of the authentication request 145.

As illustrated in FIG. 6, the function authentication table 130 is a table in which a function name 132, an authorized user 134, and an authentication type 136 are associated with one another, and which is stored, for example, in the auxiliary storage device 75 of the virtual PC server 5. The function name 132 represents a name indicating a function in the application 37 or the driver 39 which is to be executed in the virtual PC server 5. The authorized user 134 represents a name of a user authorized to use the function of the function name 132. The authentication type 136 represents a type of authentication set for use of the function of the function name 132. As the authentication type 136, for example, vein authentication, fingerprint authentication, face authentication, and the like are described, but the authentication type 136 may be authentication using an integrated circuit (IC) card or authentication using a security code.

As illustrated in FIG. 7, the authentication request 145 is information that is to be output from the authentication management unit 121 to the client terminal 3, and may include, for example, a “command”, a “return destination IP”, a “return destination port number”, and an “authentication type”. In this case, the “command” is information indicating an authentication request. The “return destination IP” and the “return destination port number” are information indicating a return destination of authentication information and, for example, information indicating the virtual PC server 5 or the authentication server 15. The “authentication type” is information indicating the type of authentication information that the authentication relay unit 103 of the client terminal 3 acquires.

The authentication management unit 121 issues a request for acquisition of authentication information to the client terminal 3, based on a request from the authentication request section 125, transmits acquired authentication information to the authentication server 15, receives a authentication result from the authentication server 15, informs the application processing unit 123 of the authentication result, and the like, and thus, manages authentication. The authentication management unit 121 may assume authentication information that is to be acquired as authentication of the authentication type of which, for example, the authentication request section 125 has informed by referring to the function authentication table 130.

Returning to FIG. 5, the authentication server 15 includes an authentication section 129. The authentication section 129 is a function that is realized by executing the authentication program 41. The authentication section 129 performs authentication based on comparison between authentication information received from the virtual PC server 5 or the client terminal 3 and information stored in the user information DB 43, and outputs an authentication result. The user information DB 43 includes a user authentication table 150.

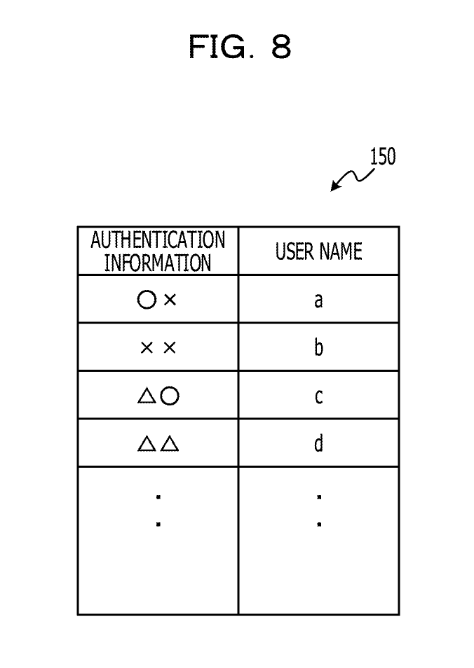

FIG. 8 is a diagram illustrating an example of the user authentication table 150. As illustrated in FIG. 8, the user authentication table 150 is a table in which authentication information and a user name are associated with one another. The user authentication table 150 is stored in, for example, the user information DB 43. The user authentication table 150 is a table to which the authentication section 129 refers to determine whether there is authentication information that matches the received authentication information and which is used, if there is authentication information that matches the received authentication information, for extracting the corresponding user name. Note that the user authentication table 150 preferably includes information for all of users. In this case, in the user authentication table 150, when a user corresponding to authentication information is extracted, the user is an authorized user for use of the virtual PC server 5.

In the information processing system 1 configured in the above-described manner, the terminal authentication unit 101 of the client terminal 3 performs intercommunication with the authentication section 129 of the authentication server 15. The authentication relay unit 103 of the client terminal 3 performs intercommunication with the authentication management unit 121 of the virtual PC server 5. The authentication section 129 of the authentication server 15 checks the received authentication information against the user information DB 43 and performs authentication processing. When the authentication section 129 completes authentication processing, the authentication section 129 returns an authentication result to an authentication request source.

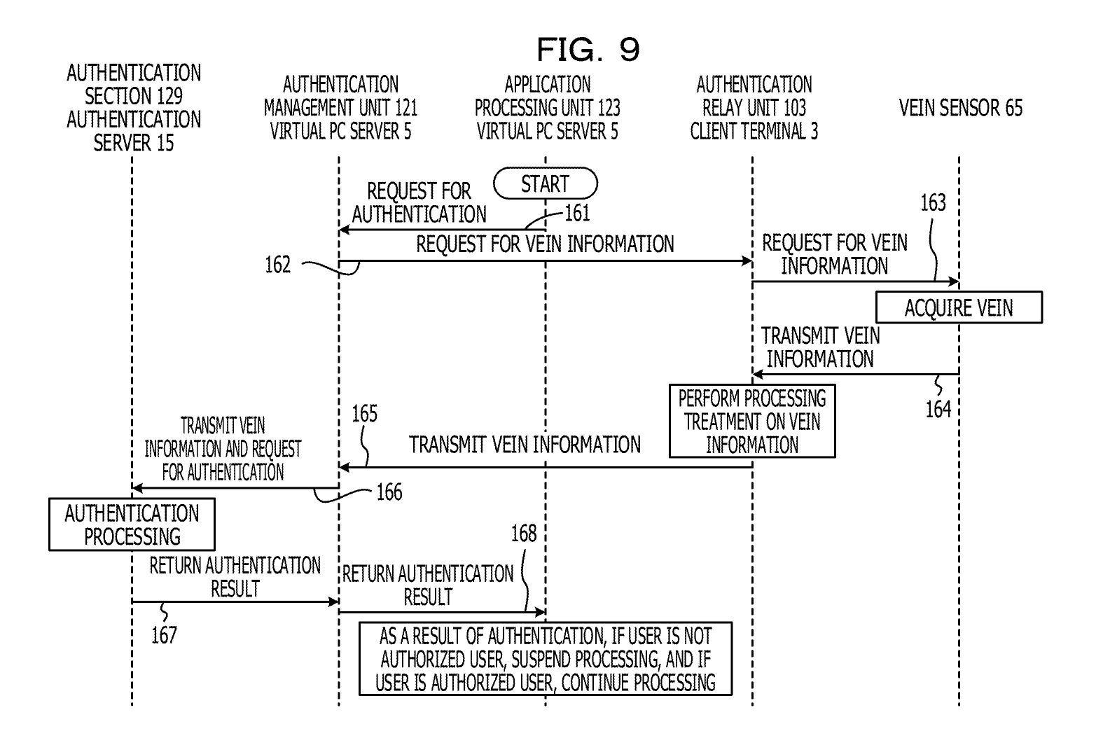

FIG. 9 is a diagram conceptually illustrating the above-described series of processes. FIG. 9 illustrates the authentication section 129, the authentication management unit 121, the application processing unit 123, the authentication relay unit 103, and the vein sensor 65. The processing illustrated in FIG. 9 is processing that is performed when authentication related to use of the application 37 or the driver 39 is performed, after the client terminal 3 is already authorized to use the virtual PC server 5.

As illustrated in FIG. 9, for example, in order to confirm whether or not the user is an authorized user relative to a startup request from the client terminal 3, the application processing unit 123 issues a request for authentication to the authentication management unit 121, which is indicated by a request 161. The authentication management unit 121 issues a request for authentication information, such as, for example, vein information, to the authentication relay unit 103 of the client terminal 3, which is indicated by a request 162. The authentication relay unit 103 of the client terminal 3 issues a request for acquisition of information to the vein sensor 65, which is indicated by a request 163. The vein sensor 65 acquires vein information and transmits the vein information to the authentication relay unit 103, which is indicated by a communication 164.

In the authentication relay unit 103, predetermined processing, such as encryption of the vein information, is performed, the encrypted vein information is transmitted to the authentication management unit 121 of the virtual PC server 5, which is indicated by a communication 165. The authentication management unit 121 of the virtual PC server 5 transmits authentication information to the authentication section 129 of the authentication server 15 to request authentication, which is indicated by a request 166. The authentication section 129 performs authentication processing in which a user stored in association with authentication information that matches the received authentication information is extracted, and returns an authentication result to the authentication management unit 121 of the virtual PC server 5, which is indicated by a communication 167. The authentication result may be information indicating whether or not the user has been authenticated.

The authentication management unit 121 returns a result to the application processing unit 123, which is indicated by a communication 168. In the application processing unit 123, for example, the function authentication table 130 is referred to, if the authentication result indicates that the user is not an authorized user, processing is suspended, and, if the authentication result indicates that the user is an authorized user, the processing is continued. For example, when the application processing unit 123 determines that it would not permit the user to use a function, the application processing unit 123 outputs an error to inform the user that the user may not use the function and then suspends processing. If the application processing unit 123 determines that it would permit the user to use the function, the application processing unit 123 provides the function to the user as requested.

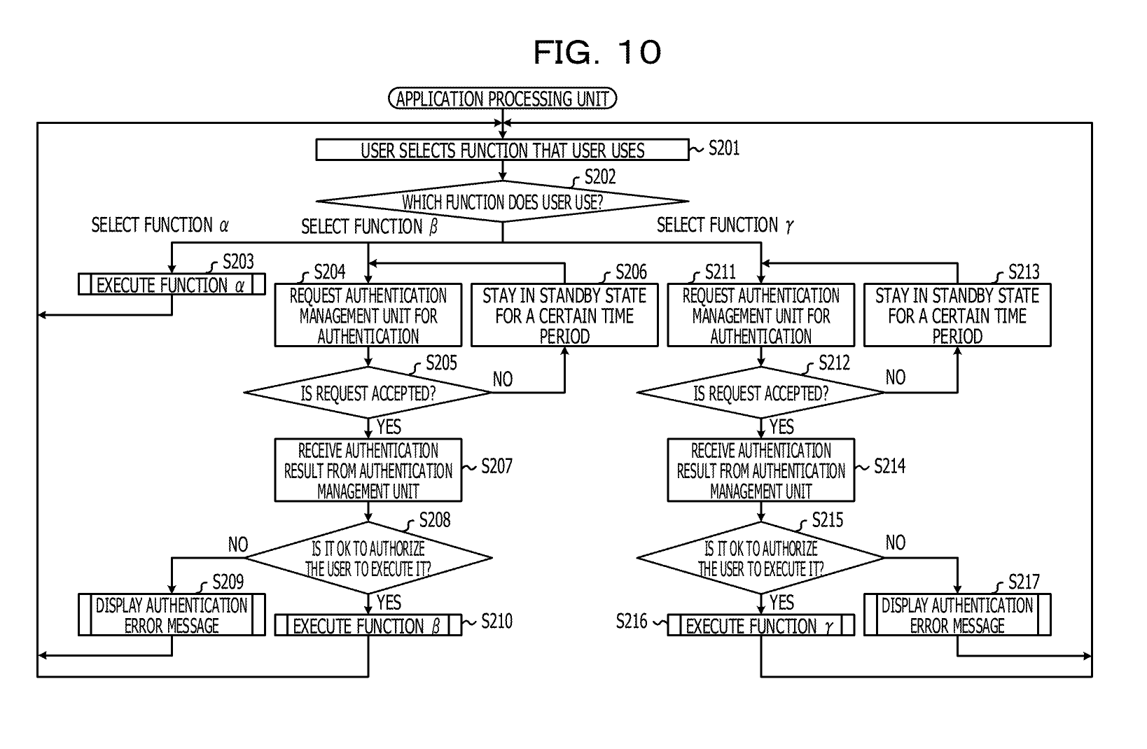

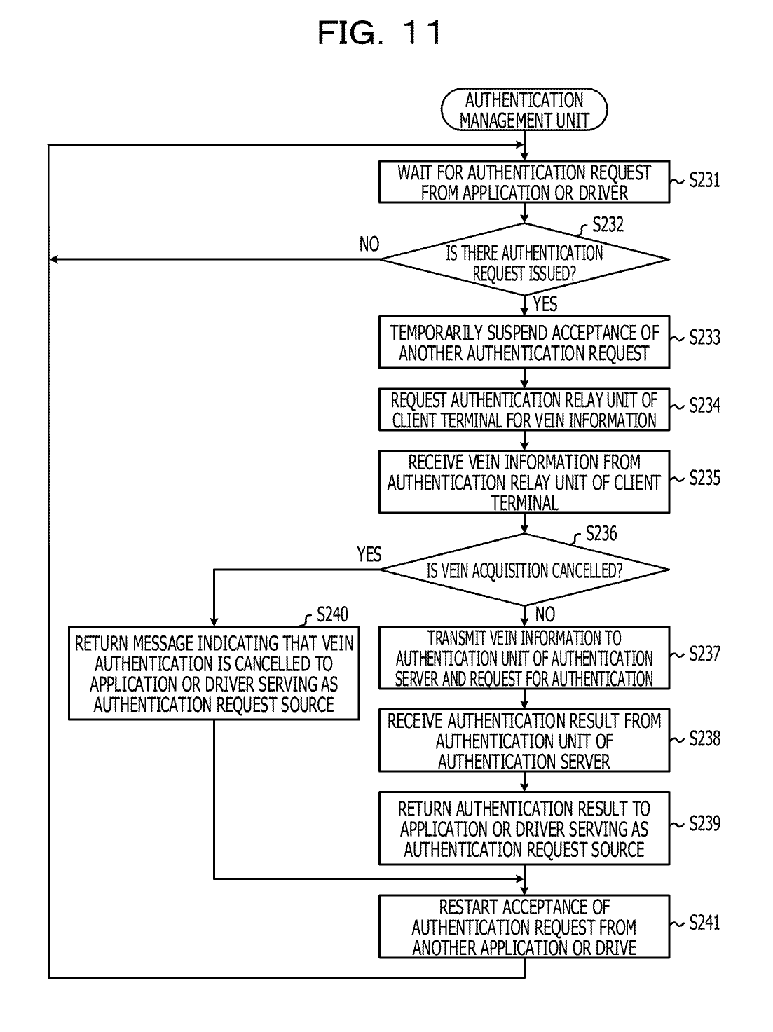

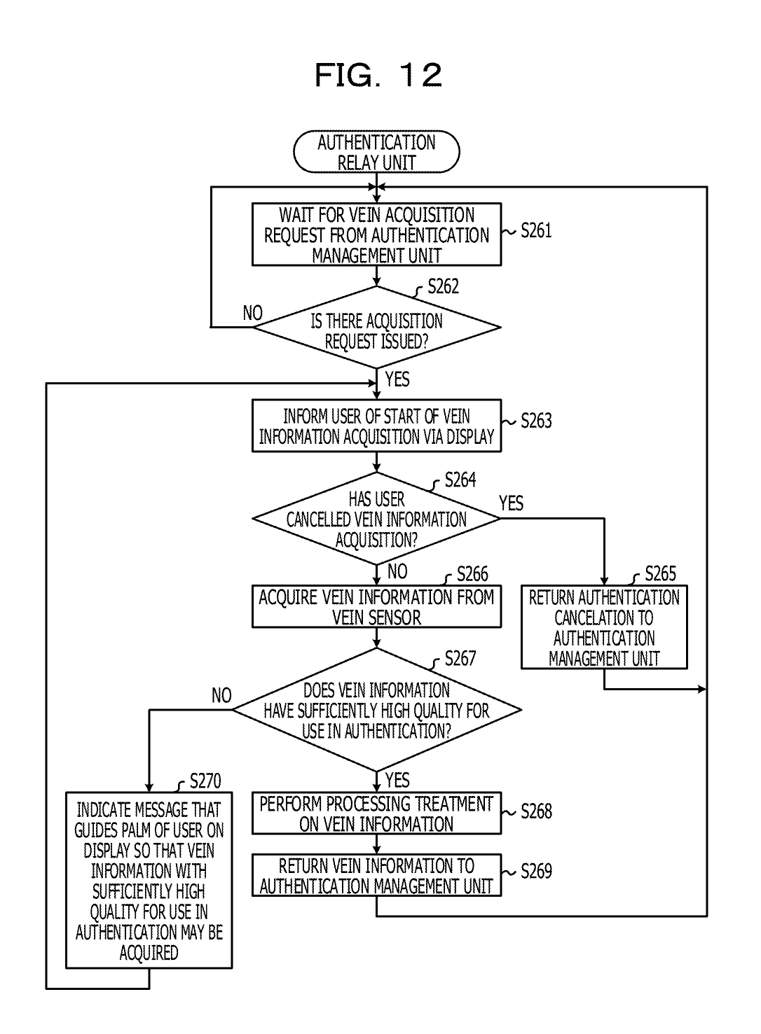

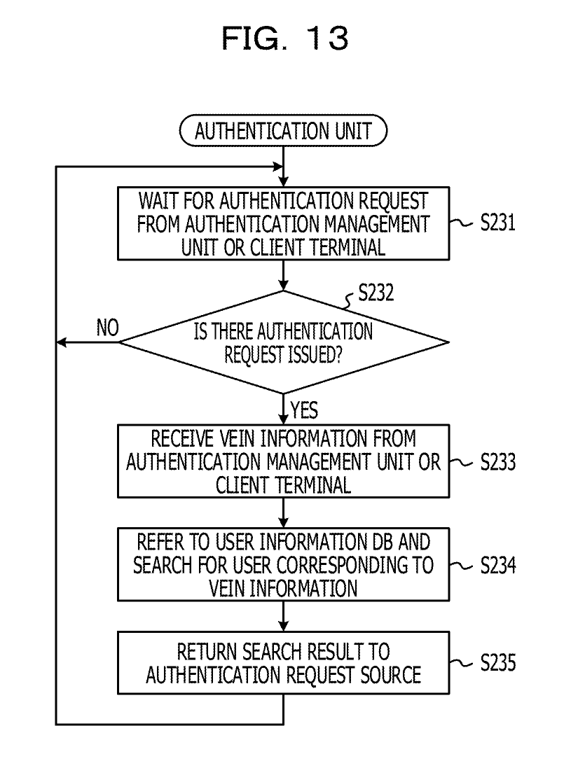

The operation of the information processing system 1 will be further described hereinafter with reference to flowcharts of FIGS. 10 to 13. In the following description, an example where vein authentication is performed as authentication will be described. FIG. 10 is a flowchart illustrating an example of the operation of the application processing unit 123, FIG. 11 is a flowchart illustrating an example of the operation of the authentication management unit 121, FIG. 12 is a flowchart illustrating an example of the operation of the authentication relay unit 103, and FIG. 13 is a flowchart illustrating example processing of the authentication unit 129.

As illustrated in FIG. 10, in the following description, it is assumed that the application processing unit 123 executes processing related to the application 37 having three functions. Note that the application processing unit 123 is an example of a function of executing one of the application 37 and the driver 39.

The application processing unit 123 causes, for example, the display 59 of the client terminal 3 to display options to thereby let the user select a function. When the application processing unit 123 detects that the user selected a function that the user is to use (S201), the application processing unit 123 urges the client terminal 3 to select the function that the user is to use (S202).

FIG. 10 illustrates an example where the application 37 has three types of functions, that is, functions α, β, and γ. Assume that, among the three functions, any user who may log on the virtual PC server 5 may execute the function α. The functions β and γ are functions for which authentication is performed. When the function α is selected, the application processing unit 123 executes the function α in S203, and repeats the processing from S201.

When the function β is selected, the application processing unit 123 issues a request for authentication to the authentication management unit 121 (S204). In this case, for example, the application processing unit 123 may refer to the function authentication table 130 to thereby acquire the corresponding authentication type 136 and inform the authentication management unit 121 of the authentication type 136.

When the authentication management unit 121 does not accept the request (No in S205), the application processing unit 123 is put into a standby state for a certain time period (S206) and then repeats the processing from S204. When the request is accepted (YES in S205), the application processing unit 123 receives an authentication result from the authentication management unit 121 (S207) and determines based on the authentication result whether or not the user is an authorized user for use of the function β (S208). In this case, the application processing unit 123 may refer to, for example, when the authentication management unit 121 informs of the user name corresponding to the authentication information, the function authentication table 130 and determine whether or not there is the informed user name in the authorized user 134 corresponding to the function β.

If the user is not an authorized user (NO in S208), the application processing unit 123 causes the client terminal 3 to display an authentication error message (S209) and repeats the processing from the S201. In S208, if it is determined that the user is an authorized user for use of the function β (YES in S208), the application processing unit 123 executes the function β (S210) and repeats the processing from S201.

When the function γ is selected, the application processing unit 123 issues a request for authentication to the authentication management unit 121 (S211). When the authentication management unit 121 does not accept the request (No in S212), the application processing unit 123 is put into a standby state for a certain time period (S213) and then repeats the processing from S211. When the request is accepted (YES in S212), the application processing unit 123 receives an authentication result from the authentication management unit 121 (S214) and determines based on the authentication result whether or not the user is an authorized user for use of the function γ (S215). In this case, the application processing unit 123 may refer to, for example, when the authentication management unit 121 informs of the user name corresponding to the authentication information, for example, the function authentication table 130 and determine whether or not there is the informed user name in the authorized user 134 corresponding to the function γ.

If it is determined that the user is an authorized user for use of the function γ (YES in S215), the application processing unit 123 executes the function γ (S216) and repeats the processing from S201. If the user is not an authorized user (NO in S215), the application processing unit 123 causes the client terminal 3 to display an authentication error message (S217) and repeats the processing from S201.

As illustrated in FIG. 11, the authentication management unit 121 stays in a standby state, as appropriate, until an authentication request is issued from the application 37 or the driver 39 (S231). The authentication management unit 121 repeats determination on whether or not there is an authentication request issued (NO in S232). If there is an authentication request issued (YES in S232), the authentication management unit 121 issues a request for biological information, such as vein information, to the client terminal 3. In this case, the authentication management unit 121 temporarily suspends acceptance of an authentication request until the series of authentication processes are completed so that an authentication request does not come from another application or driver before the authentication management unit 121 actually issues a request for authentication information to the client terminal 3 (S233).

The authentication management unit 121 issues a request for, for example, vein information to the authentication relay unit 103 of the client terminal 3 (S234). The authentication management unit 121 receives vein information from the authentication relay unit 103 (S235). The authentication management unit 121 determines whether or not acquisition of vein information is cancelled (S236). If acquisition of vein information is not cancelled (NO in S236), the authentication management unit 121 transmits the vein information to the authentication section 129 of the authentication server 15 to request authentication (S237).

When the authentication management unit 121 acquires an authentication result from the authentication section 129 of the authentication server 15 (S238), the authentication management unit 121 returns an authentication result to the application processing unit 123 serving as an authentication request source (S239). In S236, if acquisition of vein information is cancelled (YES in S236), the authentication management unit 121 returns a message indicating that acquisition of vein information is cancelled to the application processing unit 123 serving as an authentication request source (S240), and the process proceeds to S241. The authentication management unit 121 restarts acceptance of an authentication request from another application 37 or driver 39 (S241) and repeats the processing from S231.

As illustrated in FIG. 12, the authentication relay unit 103 of the client terminal 3 stays in a standby state until a vein acquisition request is issued from the authentication management unit 121 (S261). If there is not a vein acquisition request issued (NO in S262), the authentication relay unit 103 repeats the processing from S261. If there is a vein acquisition request issued (YES in S262), before it actually acquires vein information, the authentication relay unit 103 informs the user of a start of acquisition of vein information, for example, via the display 59 (S263). Vein information is acquired from a vein sensor coupled thereto.

When it is detected that the user entered a cancellation instruction via the keyboard 61 or the like (YES in S264), the authentication relay unit 103 cancels vein information acquisition and returns a message indicating that vein information acquisition is cancelled to the authentication management unit 121 (S265). If it is not detected that the user has cancelled vein information acquisition (NO in S264). The authentication relay unit 103 controls the vein sensor 65 to acquire vein information of the user (S266).

The authentication relay unit 103 evaluates the acquired vein information and, if information with sufficiently high quality for use in authentication is acquired (YES in S267), the authentication relay unit 103 performs processing treatment, for example, so that, even when vein information runs through on the information network 13, the vein information is not unauthorizedly used (S268). In processing treatment, the authentication relay unit 103 performs data encryption so that, even when vein information is leaked by any chance while running through on the network, there would not be a problem, or conversion processing in which features of vein information are extracted to generate irreversible data from the extracted features. When processing treatment of vein information is completed, the authentication relay unit 103 returns vein information to the authentication management unit 121 (S269). Then, if the quality of the acquired vein information is not sufficiently high for use in authentication (NO in S267), a message indicating that guides the palm of the user to move up and down, to left and right, and back and forth, such that the palm of which information is to be acquired is properly placed relative to the vein sensor is displayed on the display (S270). Furthermore, the authentication relay unit 103 causes the process to return to S263 to acquire vein information again.

As illustrated in FIG. 13, the authentication section 129 stays in a standby state, as appropriate, until an authentication request is issued from the authentication management unit 121 or the client terminal 3 (S281). If there is not an authentication request issued (S282), the authentication section 129 causes the process to return to S281 and repeats the processing. If there is an authentication request issued (YES in S282), the authentication section 129 receives, for example, vein information (S283). The authentication section 129 refers to the user authentication table 150 of the user information DB 43 to search to which user the received authentication information, such as vein information, belongs (S284).

If, as a result of search, it has turned out to which user the authentication information belongs, or if it has turned out that the authentication information does not belong to any user (there is not the corresponding user), the authentication management unit 121 serving as an authentication request source returns the authentication result to the client terminal 3 (S285). After the authentication management unit 121 returns the authentication to the authentication request source, the process returns to S281 to restart acceptance of an acquisition request.

As described above, the information processing system 1 according to this embodiment enables authentication in use of the application 37 or the driver 39 stored from the client terminal 3 to the virtual PC server 5, as appropriate. In this case, the virtual PC server 5 includes the function authentication table 130 and, when the authentication request section 125 of the application processing unit 123 issues an authentication request, the authentication request section 125 refers to the function authentication table 130. In the function authentication table 130, the authorized user 134 and the authentication type 136 are associated with one another for each of functions that are realized by the application 37 or the driver 39.

When the authentication management unit 121 of the virtual PC server 5 receives an authentication request transmitted from the authentication request section 125, the authentication management unit 121 issues a request for acquisition of authentication information to the client terminal 3. The authentication relay unit 103 of the client terminal 3 controls, for example, driving of the biological authentication unit 7 corresponding to the authentication type in accordance with the authentication request 145, and acquires authentication information. If the quality of biological information acquired from the biological authentication unit 7 is low, the authentication relay unit 103 performs feedback to the user using the output device 9 in order to acquire high quality biological information. Thus, in the client terminal 3, the authentication relay unit 103 performs processing of controlling the biological authentication unit 7 in response to an instruction from the authentication management unit 121, acquiring biological information from the user, and returning the acquired biological information to the authentication management unit 121.

The authentication section 129 of the authentication server 15 searches for received authentication information in the user authentication table 150 stored in the user information DB 43, and determines whether or not the authentication information is stored in association with the user. If the authentication information is stored in the user authentication table 150, the authentication section 129 returns, as an authentication result, the corresponding identification information of the user and, if not, the authentication section 129 returns a message indicating that the authentication information is not stored in the user authentication table 150 to the authentication management unit 121. The authentication management unit 121 returns the authentication result to the application processing unit 123, and the application processing unit 123 determines whether or not the user is authorized to use the application 37, the driver 39, or each of functions thereof in accordance with the authentication result and performs processing in accordance with the determination.

As described above, in the information processing system 1, authentication may be performed for each of the application 37 and the driver 39, and furthermore, for each of functions thereof. Thus, even for the user authorized to use the virtual PC server 5, authentication may be performed for each of the application 37 and the driver 39, or for each of functions thereof, thereby enabling control of use thereof and improving convenience. In this case, if the client terminal 3 includes a plurality of authentication information detection units, authentication by the biological authentication unit 7 of a type in accordance with the application 37, the driver 39, or each of functions thereof may be performed. Thus, authentication in accordance with a security level may be set for each function, and various other uses are enabled.

When a different function range of an application or a drive which a user is permitted to use is set for each user, it is possible to perform an operation in accordance with each user without performing control in which a plurality of virtual PCs 120 is ensured in the virtual PC server 5, each of structures of the virtual PCs 120 is changed for each user, and then an operation is performed. As described above, in the application 37 and the driver 39, a desired function may be provided in accordance with each user. Thus, an operation in accordance with each user is enabled by a single virtual PC server 5, resulting in reduction in resource cost of a virtual PC environment.

For example, examples of functions of the application 37 and the driver 39 include a function of referring to a sentence, a function of character rewrite, a function of character conversion, and the like, in a document creation application.

### First Modified Example

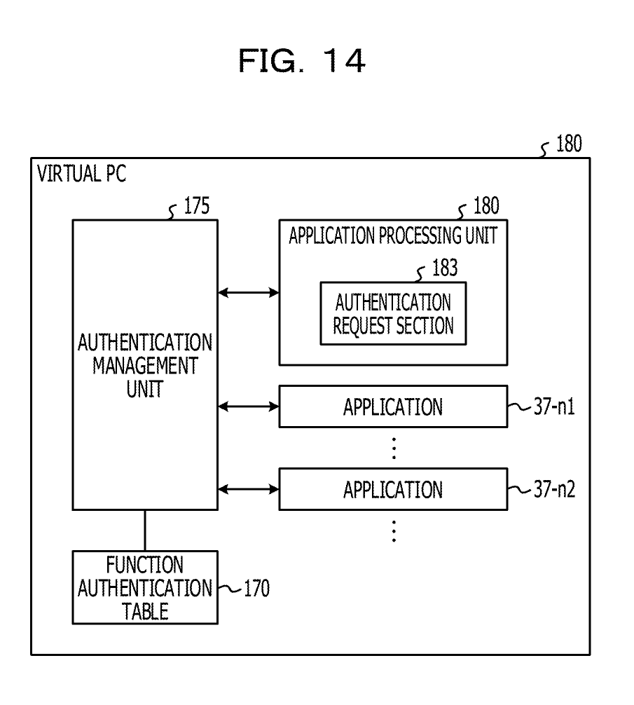

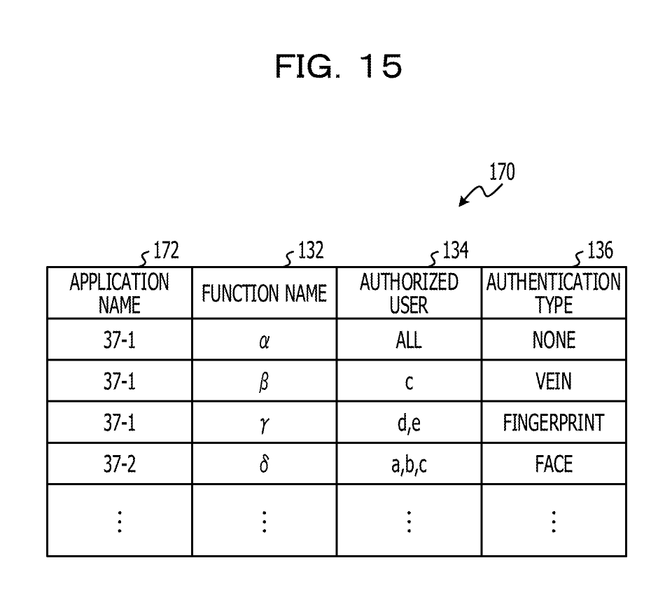

A first modified example of the information processing system 1 according to the above-described embodiment will be hereinafter described with reference to FIG. 14 and FIG. 15. According to this modified example, instead of the function authentication table 130, a function authentication table 170 is provided, and a condition at the time of the issuance of an authentication request is set at the authentication management unit 121 side. Each structure and operation similar to those of the above-described embodiment is denoted by the same reference numeral, and therefore, the detail description thereof will be omitted. In this modified example, the entire configuration of the information processing system 1 and respective hardware configurations of the client terminal 3, the virtual PC server 5, and the authentication server 15 are similar to those described in the above.

FIG. 14 is a block diagram illustrating the function of a virtual PC 180 according to this modified example. As illustrated in FIG. 14, the virtual PC 180 includes, in addition to the application 37-n1 and the driver 39-n2, an authentication management unit 175, the function authentication table 170, and an application processing unit 181. The application processing unit 181 includes an authentication request section 183.

FIG. 15 is a diagram illustrating an example of the function authentication table 170. The function authentication table 170 includes, in addition to the function authentication table 130, an application name 172. In this modified example, the authentication request section 183 informs the authentication management unit 175 of an application name and a function for which authentication is performed. The authentication management unit 175 refers to the function authentication table 170, extracts the application name 172 for which authentication is to be performed and the authentication type 136 in accordance with the function name 132, and issues an authentication request to the authentication relay unit 103. When the authentication management unit 175 is informed of an authentication result, the authentication management unit 175 refers to the function authentication table 170, determines whether or not the user is an authorized user, and informs the application processing unit 181 of the authentication result.

According to this modified example, the function authentication table 130 is not provided for each of the application 37 or the driver 39, but a common function authentication table 170 may be provided. The application processing unit 181 does not perform processing of referring to a table. According to this modified example, similar work effects to those of the information processing system 1 according to the above-described embodiment may be achieved.

### Second Modified Example

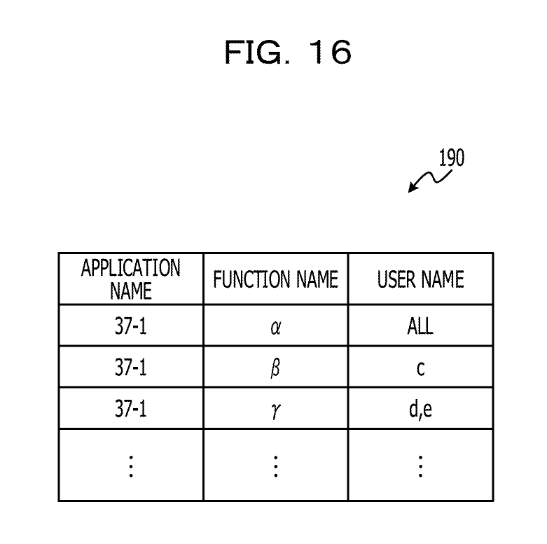

A modified example of the information processing system 1 according to the above-described embodiment will be described with reference to FIG. 16. According to this modified example, the user information DB 43 further include an app authentication table 190, and the user name is not returned as an authentication result from the authentication section 129 to the authentication management unit 121 but whether or not an authentication target user may use an authentication target function is returned thereto as an authentication result. Each structure and operation similar to those of the above-described embodiment is denoted by the same reference numeral, and therefore, the detail description thereof will be omitted. In this modified example, the entire configuration of the information processing system 1 and respective hardware configurations of the client terminal 3, the virtual PC server 5, and the authentication server 15 are similar to those described in the above.

FIG. 16 is a diagram illustrating an example of the app authentication table 190. As illustrated in FIG. 16, in the app authentication table 190, the name of the application 37 or the driver 39, the function name of a function in the application 37 or the driver 39, and a user name of a user authorized for use of the function are stored in association with one another. When a user is specified by the user authentication table 150, the app authentication table 190 is used for acquiring information on whether or not the user is authorized for use of each function of the application 37 or the driver 39.

When the user name is specified by referring to the user authentication table 150, the authentication section 129 further refers to the app authentication table 190, determines whether or not the specified user is authorized for use of an authentication target function, and returns a result to the authentication management unit 121. In this modified example, a table that does not include the authentication type 136 in the function authentication table 170 may be used.

In this modified example, determination on whether or not the user is authorized for use of the application 37, the driver 39, or functions thereof is executed by the authentication server 15, and returns a determination result to the virtual PC server 5. Thus, in addition to advantages achieved by the above-described embodiment and the first modified example, the advantage of reduction of the number of processes performed in the virtual PC server 5 may be achieved.

Note that the present disclosure is not limited to the above-described embodiment but various configurations and embodiments may be employed within the range not departing from the gist of the disclosure. For example, the function authentication table 130, the user authentication table 150, the function authentication table 170, and the like are not limited to the above-described examples, but may be modified to substantially similar examples. As the client terminal 3, an example including the auxiliary storage device 55 has been described, but the client terminal 3 is not limited thereto. For example, a terminal for exclusive use of a thin client, which does not include the auxiliary storage device 55 may be used as the client terminal 3. In this case, the terminal authentication program 23 and the relay program 25 may be stored in the memory 53 and may be used as one of the application 37 of the virtual PC server 5. An example wherein the virtual PC server 5 and the authentication server 15 are separate devices has been described, but a configuration wherein the virtual PC server 5 has the function of the authentication server 15 may be employed.

In the above-described embodiment, the first modified example, and the second modified example, the virtual PC server 5 is an example of an information processing unit, the client terminal 3 is an example of a client terminal unit, and the authentication server 15 is an example of an authentication unit. The network adapter 57 and the network adapter 57 are examples of communication circuit, and the auxiliary storage device 55, the auxiliary storage device 75, and the auxiliary storage device 95 are examples of a memory. The CPU 51 and the CPU 71 are examples of an arithmetic processing unit, the keyboard 61 and the mouse 63 are examples of an input section, and the keyboard 61, the vein sensor 65, and the camera 67 are examples of an authentication information detection section.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing unit comprising:
a communication circuit configured to communicate with a client terminal device;
a memory configured to store a program used for executing given processing; and
a processor coupled to the memory, configured to
issue, when the given processing includes processing of requesting authentication in accordance with a use request received from the client terminal device related to use of the program, an acquisition request of authentication information used for performing the authentication to the client terminal device, and
determine, when the processor acquires an authentication result in accordance with the authentication information, whether or not the given processing that is to be performed by the program is executed, based on the authentication result.

2. The information processing unit according to claim 1,
wherein the processor is configured to request the authentication of a type in accordance with the program in processing of requesting the authentication.

3. The information processing unit according to claim 1,
wherein the processor is configured to request the authentication of a type in accordance with each of a plurality of functions that are realized by executing the program in processing of requesting the authentication.

4. The information processing unit according to claim 1,
wherein the memory is configured to further store correspondence of the program that is to be a authentication target and a user authorized to use the program, correspondence of the program and the type of the authentication, correspondence of a plurality of functions that are realized by executing the program and a user authorized to use each of the plurality of functions, and correspondence of the function and the type of the authentication, and
the processor is configured to request the authentication by referring to the at least one of the correspondences stored in the memory.

5. The information processing unit according to claim 4,
wherein the processor is configured to determine, when the processor acquires the authentication result, whether or not the given processing that is to be performed by the program is to be executed by referring to the at least one of the correspondences stored in the memory.

6. A client terminal device comprising:
a memory configured to store a second program for using a first program provided in an information processing unit by communicating with the information processing unit;
an input section configured to accept a use request entered by a user;
a communication circuit configured to transmit the use request related to use of the first program to the information processing unit and to receive an acquisition request transmitted from the information processing unit in accordance with the use request; and
a processor coupled to the memory and configured
to read the second program to execute the second program,
to acquire, when the communication circuit receives the acquisition request, authentication information related to the use of the first program based on the received acquisition request, and
to instruct the communication circuit to transmit the authentication information.

7. The client terminal device according to claim 6,
wherein the processor is configured to acquire the authentication information in accordance with a type of the acquisition request.

8. The client terminal device according to claim 6,
wherein the use request is related to use of a function that is realized by executing the first program.

9. An information processing system comprising:
an information processing unit;
a client terminal device; and
an authentication unit,
the information processing unit, the client terminal device, and the authentication unit being coupled to one another via an information communication network,
wherein
the information processing unit includes
a first communication circuit configured to communicate with the client terminal device, and
a first memory configured to store a first program used for executing given processing,
a first processor configured to issue, when the given processing includes processing of requesting authentication in accordance with a use request received from the client terminal device related to use of the first program, an acquisition request of authentication information used for performing the authentication to the client terminal device and to determine, when the first processor acquires an authentication result in accordance with the authentication information, whether or not the given processing that is to be performed by the first program in accordance with the use request is to be executed, based on the authentication result,
the client terminal device includes
a second memory configured to store a second program for using the first program provided in the information processing unit by communicating with the information processing unit,
an input section configured to accept the use request entered by a user,
a second communication circuit configured to transmit the use request accepted by the input section to the information processing unit and to receive the acquisition request transmitted from the information processing unit in accordance with the use request, and
a second processor configured to read the second program to execute the second program, to acquire, when the second communication circuit receives the acquisition request, the authentication information based on the received acquisition request, and to instruct the communication circuit to transmit the authentication information, and
the authentication unit is configured to perform the authentication based on the authentication information and to output the authentication result to the information processing unit.

10. The information processing system according to claim 9,
wherein the authentication of a type in accordance with the program is requested in processing of requesting the authentication.

11. The information processing system according to claim 9,
wherein the use request is related to use of a function that is realized by executing the first program.

12. The information processing system according to claim 9,
wherein the authentication unit includes a memory configured to store correspondence of the least one first program that is to be an authentication target and a user authorized to use the first program, correspondence of the first program and the type of the authentication, correspondence of a plurality of functions that are realized by executing the first program and a user authorized for use of each of the plurality of functions, and correspondence of the function and the type of the authentication.

13. An authentication processing method comprising:
causing an information processing unit to issue, when a program includes processing of requesting authentication in accordance with a use request received from a client terminal device related to use of the program, an acquisition request of authentication information used for performing the authentication to the client terminal device;
causing the client terminal device to acquire, when the client terminal device receives the acquisition request in accordance with the use request, the authentication information related to the use of the program and to output the authentication information;
causing an authentication unit to perform the authentication based on the authentication information and to output an authentication result of the authentication to the information processing unit; and
causing the information processing unit to determine, by a processor, when the information processing unit acquires the authentication result in accordance with the authentication information, whether or not given processing that is to be performed by the program is executed, based on the authentication result.

14. The method according to claim 13,
wherein the authentication of a type in accordance with the program is requested in processing of requesting the authentication.

15. The method according to claim 13,
wherein the use request is related to use of a function that is realized by executing the program.
